(19) United States
(12) Patent Application Publication
(10) Pub. No.: US 2019/0163201 A1
(43) Pub. Date: May 30, 2019

(54) Autonomous Vehicle Sensor Compensation Using Displacement Sensor

(71) Applicant: Uber Technologies, Inc., San Francisco, CA (US)

(72) Inventors: Kenneth James Jensen, Alameda, CA (US); Mike Carter, La Jolla, CA (US); Soren Juelsgaard, San Francisco, CA (US)

(21) Appl. No.: 15/855,364

(22) Filed: Dec. 27, 2017

Related U.S. Application Data
(60) Provisional application No. 62/592,529, filed on Nov. 30, 2017.

(51) Int. Cl. G05D 1/02; B60W 40/10; B62D 33/06

(52) U.S. Cl. CPC G05D 1/0268; B60W 40/10; B62D 33/0608; G01S 19/13; B60W 2520/18; B60W 2520/14; B60W 2520/16

(57) ABSTRACT

Systems and methods for compensating for displacement-related sensor mismatch of an autonomous vehicle are provided. An autonomous vehicle can define a pitch axis and a roll axis. The pitch axis can be perpendicular to the roll axis. A system can include one or more processors, and one or more tangible, non-transitory, computer readable media that collectively store instructions that when executed by the one or more processors cause the computing system to perform operations. The operations can include obtaining data indicative of a displacement of a first portion of the autonomous vehicle relative to a second portion of the autonomous vehicle. The operations can further include determining an orientation of the first portion relative to the second portion about at least one of the pitch axis or the roll axis based at least in part on the data indicative of the displacement.

### PRIORITY CLAIM

The present application is based on and claims priority to U.S. Provisional Application 62/592,529 having a filing date of Nov. 30, 2017, which is incorporated by reference herein.

### FIELD

The present disclosure relates generally to compensating for displacement-related sensor mismatch. More particularly, the present disclosure relates to systems and methods for compensating for displacement-related sensor mismatch of an autonomous vehicle.

### BACKGROUND

An autonomous vehicle is a vehicle that is capable of sensing its environment and navigating with minimal or no human input. In particular, an autonomous vehicle can observe its surrounding environment using a variety of sensors and can attempt to comprehend the environment by performing various processing techniques on sensor data collected by the sensors. Given knowledge of its surrounding environment, the autonomous vehicle can identify an appropriate motion path through such surrounding environment.

Thus, a key objective associated with an autonomous vehicle is the ability to determine the position and/or orientation of the autonomous vehicle relative to the surrounding environment. However, in some autonomous vehicle applications, such as on an autonomous truck, different portions of the autonomous vehicle may move relative to one another. For example, a suspension (e.g., an air-ride suspension) positioned between a cab portion and a chassis portion of an autonomous truck may allow the cab portion to pitch and/or roll relative to the chassis portion as the autonomous truck travels over various terrain features. In some situations, the pitch and/or roll of the cab portion relative to the chassis portion may cause sensor-related mismatch. For example, as the cab portion pitches or rolls relative to the chassis portion, measurements from a first sensor located on the cab portion may not match measurements obtained from a second sensor positioned on the chassis portion.

Further, in some situations, the pitch and/or roll of the cab portion relative to the chassis portion can cause the autonomous vehicle to misinterpret data from one or more sensors. For example, as the cab pitches or rolls, signals reflected off of the ground from a light detection and ranging (LIDAR) sensor positioned on the cab portion may be misinterpreted by the autonomous vehicle's autonomy system as an obstacle in front of the autonomous vehicle. Moreover, in some applications, reflected LIDAR signals, such as a point cloud, may be used to determine a position of the autonomous vehicle within the surrounding environment by comparing the point cloud to previously obtained point clouds and/or map data. However, when the cab portion pitches and/or rolls relative to the chassis portion, such LIDAR data may be misinterpreted, which can cause errors in determining the position of the autonomous vehicle.

### SUMMARY

Aspects and advantages of embodiments of the present disclosure will be set forth in part in the following description, or can be learned from the description, or can be learned through practice of the embodiments.

One example aspect of the present disclosure is directed to a system for compensating for displacement between portions of an autonomous vehicle. The autonomous vehicle can define a pitch axis and a roll axis. The pitch axis can be perpendicular to the roll axis. The system can include one or more processors, and one or more tangible, non-transitory, computer readable media that collectively store instructions that when executed by the one or more processors cause the computing system to perform operations. The operations can include obtaining data indicative of a displacement of a first portion of the autonomous vehicle relative to a second portion of the autonomous vehicle. The operations can further include determining an orientation of the first portion relative to the second portion about at least one of the pitch axis or the roll axis based at least in part on the data indicative of the displacement.

Another example aspect of the present disclosure is directed to a method for compensating for displacement between portions of an autonomous vehicle. The autonomous vehicle can define a pitch axis and a roll axis. The pitch axis can be perpendicular to the roll axis. The method can include obtaining, by a computing system comprising one or more computing devices, data indicative of a displacement of a first portion of the autonomous vehicle relative to a second portion of the autonomous vehicle from one or more displacement sensors. The method can further include determining, by the computing system, an orientation of the first portion relative to the second portion about the pitch axis or the roll axis based at least in part on the data indicative of the displacement.

Another example aspect of the present disclosure is directed to a vehicle. The vehicle can define a pitch axis, a roll axis, and a vertical direction. The pitch axis can be perpendicular to the roll axis. The vertical direction can be perpendicular to the pitch axis and the roll axis. The vehicle can include a chassis, a cab mounted atop the chassis along the vertical direction, a first displacement sensor associated with at least the pitch axis, a second displacement sensor associated with at least the roll axis, and a computing system. The first displacement sensor can be configured to obtain measurements of a displacement of the cab relative to the chassis in the vertical direction. The second displacement sensor can be configured to obtain measurements of a displacement of the cab relative to the chassis in the vertical direction. The computing system can include one or more processors, and one or more tangible, non-transitory, computer readable media that collectively store instructions that when executed by the one or more processors cause the computing system to perform operations. The operations can include obtaining data indicative of a displacement of the cab relative to the chassis from the first displacement sensor or the second displacement sensor. The operations can further include determining an orientation of the cab relative to the chassis about at least one of the pitch axis or the roll axis based at least in part on the data indicative of the displacement.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example system overview according to example aspects of the present disclosure;

FIG. 2 depicts a side view of an example autonomous vehicle according to example aspects of the present disclosure;

FIG. 3 depicts a top-down view of an example autonomous vehicle according to example aspects of the present disclosure;

FIG. 4 depicts a perspective view of an example autonomous vehicle according to example aspects of the present disclosure;

FIG. 5 depicts a perspective view of an example autonomous vehicle according to example aspects of the present disclosure;

FIG. 6 depicts a diagram of example vehicle movement of a first portion relative to a second portion of an autonomous vehicle according to example aspects of the present disclosure;

FIG. 7 depicts a diagram of example vehicle movement of a first portion relative to a second portion of an autonomous vehicle according to example aspects of the present disclosure; and

FIG. 8 depicts a flow diagram of an example method of compensating for displacement-related sensor mismatch of an autonomous vehicle according to example aspects of the present disclosure.

### DETAILED DESCRIPTION

Example aspects of the present disclosure are directed to systems and methods for compensating for displacement (e.g., linear displacement) between portions of a vehicle. The vehicle can be, for example, an autonomous vehicle which can drive, navigate, operate, etc. with minimal and/or no interaction from a human driver to provide a vehicle service. By way of example, an autonomous vehicle can be an autonomous truck that is configured to autonomously navigate to deliver a shipment to a destination location. In order to autonomously navigate, the autonomous truck can include a plurality of sensors (e.g., light detection and ranging (LIDAR) sensors, radio detection and ranging (RADAR) sensors, cameras, inertial measurement units (IMUs), wheel odometry sensors, etc.) configured to obtain sensor data associated with the vehicle's surrounding environment. For instance, one or more first sensors can be located onboard a chassis portion of the autonomous truck and one or more second sensors can be located onboard a cab portion of the autonomous truck. The sensor data can be used by a vehicle autonomy system (e.g., an autonomous vehicle computing system) to navigate the autonomous truck through the surrounding environment. The cab portion and the chassis portion can move relative to one another (e.g., via a suspension system associated with the cab, etc.). Such movement can cause the vehicle's sensor(s) to move in relation to one another such that measurements from two or more of the sensors do not match.

For example, in some implementations, an IMU, a LIDAR sensor, a camera, and/or other sensors can be located on a first portion (e.g., a cab) of the vehicle, whereas a RADAR sensor, one or more wheel odometry sensors, and/or other sensors can be located on a second portion (e.g., a chassis). For example, an IMU can include one or more accelerometers and/or one or more gyroscopes, and can be configured to obtain acceleration measurements along various axes (e.g., in three dimensions). Each wheel odometry sensor can be configured to obtain measurements of the rotation of a wheel, which can be used to determine a position, a velocity and/or an acceleration of the autonomous vehicle. LIDAR and/or RADAR sensors can be configured to send and receive reflected signals to determine the location of objects in the surrounding environment. Similarly, cameras can be used to obtain imagery of objects in the surrounding environment.

However, when the first portion (e.g., cab) of the vehicle pitches or rolls in relation to the second portion (e.g., chassis), such as due to the vehicle travelling over a pothole or other roadway feature, the measurements and/or data from sensors on the first portion and measurements and/or data from sensors on the second portion may not match due the relative movement of the two portions. This, in turn, can cause sensor data to be misinterpreted by the vehicle autonomy system. For example, during operation of an autonomous truck, a LIDAR sensor positioned on the cab portion can obtain data indicative of objects within the surrounding environment, such as sensor data indicative of a location/position of the ground on which the vehicle is travelling, and data from a wheel odometry sensor on the chassis portion can be used to determine a position/velocity/acceleration of the autonomous truck. When the cab portion pitches or rolls relative to the chassis portion, such as due to the autonomous truck hitting a pothole, the relative movement (e.g., linear displacement) of the two portions can cause sensor data from the two sensors to mismatch. For example, the cab portion may pitch forward due to an upward acceleration from traveling over the pothole, whereas the wheel odometry sensor may not indicate any acceleration occurred. In some instances, this relative movement of the two portions and/or sensor data mismatch can cause the vehicle autonomy system to interpret the ground as an obstacle in front of the autonomous vehicle, and therefore control the autonomous vehicle to a stop in response to the interpreted obstacle. For example, a point cloud from a LIDAR sensor reflecting off of the ground may be interpreted by the vehicle's autonomy system as an obstacle in front of the vehicle, and in response, control the vehicle to a stop.

In accordance with the present disclosure, one or more sensors, such as displacement or linear displacement sensors, can be configured to obtain measurements of a displacement, such as a linear displacement, of a first portion of a vehicle relative to a second portion of the vehicle. A computing system of the vehicle can be configured to compensate for linear-displacement between two portions of a vehicle. By way of example, the computing system can obtain data indicative of a displacement of the first portion relative to the second portion from the one or more displacement sensors. The computing system can further determine an orientation of the first portion relative to the second portion about a pitch axis or a roll axis based at least in part on the data indicative of the displacement. In this way, the computing system can compensate for displacement between portions of the vehicle.

More particularly, a vehicle can be an autonomous vehicle, which can be a ground-based vehicle with multiple portions that can move at least partially independent of one another. For example, the autonomous vehicle can be an autonomous truck that includes a first portion and a second portion that move at least partially independently from one another. For example, the first portion can be a cab portion and the second portion can be a chassis portion that are affixed to one another (e.g., permanently, temporarily). The cab portion can move at least partially independently from the chassis portion due to a suspension system associated with the cab portion (e.g., air suspension, spring suspension, etc.).

For example, the cab portion can move relative to the chassis portion about a pitch axis and/or a roll axis (e.g., one portion experiences a pitch, roll, etc. movement while the other does not). For example, the roll axis and the pitch axis can be perpendicular to one another, and generally define a plane parallel to the ground on which the vehicle travels. The vertical direction can be generally perpendicular to the plane defined by the pitch axis and roll axis.

According to example aspects of the present disclosure, the vehicle can include one or more displacement sensors configured to obtain measurements of a displacement of a first portion of the vehicle relative to a second portion of the vehicle. For example, in some implementations, the one or more displacement sensors can be configured to measure a displacement of the first portion of the vehicle along the vertical direction with respect to the second portion.

For example, in some implementations, the one or more displacement sensors can include a displacement sensor associated with the roll axis. For example, the displacement sensor can be located at a position remote from the roll axis (e.g., at a position not along the roll axis), and therefore configured to measure a displacement about the roll axis. In some implementations, the displacement sensor can be positioned along the pitch axis. In other implementations, the displacement sensor can be positioned at any position remote from the roll axis. In some implementations, the displacement sensor can be configured to measure a displacement along the vertical direction. For example, as the first portion of the vehicle moves about the roll axis (e.g., rolls from side to side), the displacement sensor can be configured to measure a displacement of the first portion relative to the second portion along the vertical direction.

Additionally or alternatively, in some implementations, the one or more displacement sensors can include a displacement sensor associated with the pitch axis. For example, the displacement sensor can be located at a position remote from the pitch axis (e.g., at a position not along the pitch axis), and therefore configured to measure a displacement about the pitch axis. In some implementations, the displacement sensor can be positioned along the roll axis. In other implementations, the displacement sensor can be positioned at any position remote from the pitch axis. In some implementations, the displacement sensor can be configured to measure a displacement along the vertical direction. For example, as the first portion of the vehicle moves about the pitch axis (e.g., pitches from front to back and vice-versa), the displacement sensor can be configured to measure a displacement of the first portion relative to the second portion along the vertical direction.

In some implementations, the one or more displacement sensors can include a first displacement sensor and a second displacement sensor. In some implementations, the first displacement sensor and the second displacement sensor can both be associated with the pitch axis and the roll axis. For example, the first displacement sensor and the second displacement sensor can both be located at a position remote from both the pitch axis and the roll axis (e.g., at a position not along the pitch axis or the roll axis). For example, in some implementations, the first displacement sensor and the second displacement sensor can be configured to measure a displacement along the vertical direction when the vehicle pitches and/or rolls. For example, as the first portion of the vehicle moves about the pitch axis (e.g., pitches from front to back and vice versa) and/or moves about the roll axis (e.g., rolls from side to side), the first displacement sensor and the second displacement sensor can be configured to measure a displacement along the vertical direction.

In some implementations, the one or more displacement sensors can include one or more linear encoders. For example, the one or more linear encoders can be positioned to measure a movement of the first portion of the vehicle relative to the second portion, such as along the vertical direction. In other implementations, the one or more displacement sensors can include one or more lasers or other sensors configured to obtain displacement measurements. In some implementations, the one or more displacement sensors can include one or more GPS antennas. For example, a first GPS antenna can be positioned on the first portion of the vehicle and a second GPS antenna can be positioned on the second portion. The GPS antennas can be configured to measure a displacement of the first portion relative to the second portion.

According to example aspects of the present disclosure, a computing system can be configured to obtain data indicative of displacement of the first portion relative to the second portion from the one or more displacement sensors. For example, the one or more displacement sensors can be configured to provide one or more signals to the computing system, which can receive the signals, such as via one or more wired or wireless connections. In some implementations, the computing system can be a stand-alone computing device/system, such as a stand-alone sensor computing system, while in other implementations, the computing system can be integrated into or otherwise a part of a vehicle computing device/system, such as an autonomous vehicle computing system. In some implementations, the stand-alone computing device/system can be configured to communicate with the vehicle computing device/system, such as via one or more wired or wireless networks.

The computing system can further be configured to determine an orientation of the first portion relative to the second portion about the pitch axis or the roll axis based at least in part on the data indicative of the displacement. For example, known relationships between the position of the one or more displacement sensors and a roll axis and/or pitch axis can be used to determine an orientation of the first portion relative to the second portion. For example, in some implementations, each of the first portion and the second portion can be represented by a plane, which can generally be parallel to one another at rest. However, as the first portion of the vehicle pitches or rolls, the plane representing the first portion can pitch or roll with respect to the second plane. The orientation of the first portion to the second portion can generally describe the pitch and/or roll of the first portion relative to the second portion. In some implementations, a model can be used to model the movement of the first portion relative to the second portion. In some implementations, the orientation of the first portion relative to the second portion can be determined using one or more mathematical relationships, such as, for example, the Pythagorean Theorem.

In some implementations, the computing system can be configured to determine an orientation of the first portion relative to the second portion about the roll axis by obtaining data from a displacement sensor associated with the roll axis. For example, the displacement sensor can be positioned remote from the roll axis, and can be configured to measure a displacement along the vertical direction. The computing system can be configured to receive data indicative of a displacement from the displacement sensor, and using known relationships and/or a model, determine the orientation of the first portion relative to the second portion about the roll axis from the data.

Similarly, in some implementations, the computing system can be configured to determine an orientation of the first portion relative to the second portion about the pitch axis by obtaining data from a displacement sensor associated with the pitch axis. For example, the displacement sensor can be positioned remote from the pitch axis, and can be configured to measure a displacement along the vertical direction. The computing system can be configured to receive data indicative of a displacement from the displacement sensor, and using known relationships and/or a model, determine the orientation of the first portion relative to the second portion about the pitch axis from the data.

In some implementations, the computing system can be configured to determine the orientation of the first portion relative to the second portion based at least in part on a comparison of a first displacement measurement from a first displacement sensor and a second displacement measurement from a second displacement sensor. For example, in some implementations, the first displacement sensor and the second displacement sensor can both be positioned remote from the pitch axis and the roll axis. For example, in some implementations, the first displacement sensor and the second displacement sensor can be positioned on the same side and approximately equidistant from the pitch axis, and on opposite sides of the roll axis. When both displacement sensors measure an approximately equal vertical displacement in the same direction, the computing system can be configured to determine that the first portion has pitched. When the first displacement sensor measures no vertical displacement or a negative vertical displacement and the second displacement sensor measures a positive vertical displacement, the computing system can be configured to determine that the first portion has rolled. Similarly, the computing system can be configured to determine when the first portion has pitched and rolled with respect to the second portion by comparing measurements from the first displacement sensor and the second displacement sensor.

In some implementations, a third displacement sensor can be positioned remote from first and second sensors, and measurements from the third displacement sensor can be used by the computing system. For example, the computing system can compare measurements from the first displacement sensor (or the second displacement sensor) and the third displacement sensor to determine the orientation of the first portion relative to the second portion.

In some implementations, a pose of the vehicle can be determined based at least in part on the orientation of the first portion relative to the second portion. The pose can generally describe the position and/or orientation of the vehicle in the surrounding environment. For example, in some implementations, the pose can include a roll, a pitch, or a yaw of the vehicle, or a position of the vehicle in a surrounding environment of the vehicle. For example, once the orientation of the first portion relative to the second portion has been determined, the pose of the vehicle can be determined using data from sensors on both the first portion and the second portion.

In some implementations, the pose can be determined by a state estimator, such as a state estimator of a vehicle computing system. In some implementations, the state estimator can include a Kalman filter configured to receive a plurality of inputs and determine a state of the autonomous vehicle based on the plurality of inputs. The state of the vehicle can include a pose of the vehicle, which can generally describe where the vehicle is located and how the vehicle is oriented with respect to the surrounding environment. For example, the state estimator can receive data from LIDAR sensors, accelerometers (e.g., an IMU), wheel odometry sensors, map data, GPS data, and/or other data to determine the pose of the vehicle.

In some implementations, the state estimator can include a model configured to model the first portion (e.g., cab) of the vehicle moving about a pitch axis or a roll axis with respect to the second portion (e.g., chassis). In some implementations, the model can be a rotational pendulum-spring model. Other suitable models can similarly be used. In some implementations, data obtained from the displacement sensors can be input into the model to model the movement of the first portion (e.g., cab) relative to the second portion (e.g., chassis). In some implementations, data obtained from the displacement sensors, an IMU and/or wheel odometry sensor(s) can be input into the model to model the movement of the first portion (e.g., cab) relative to the second portion (e.g., chassis) as well as the orientation and/or position of the vehicle within the surrounding environment.

In some implementations, the vehicle can be an autonomous vehicle, and the autonomous vehicle can include an autonomous vehicle computing system. The autonomous vehicle computing system can include various components to help the vehicle autonomously navigate with minimal and/or no interaction from a human driver. For example, an autonomous vehicle can include a plurality of sensors (e.g., LIDAR sensors, RADAR sensors, cameras, IMUs, wheel odometry sensors, etc.). The sensors can be configured to acquire sensor data associated with the surrounding environment of the vehicle. The sensor data can be used in a processing pipeline that includes the detection of objects proximate to the autonomous vehicle, object motion prediction, and vehicle motion planning. For example, a motion plan can be determined by the vehicle computing system, and the vehicle can be controlled by a vehicle controller to initiate travel in accordance with the motion plan. The autonomous vehicle can further include various systems configured to assist in autonomous travel. For example, a throttle system can be configured to accelerate the vehicle, a brake system can be configured to decelerate the vehicle, and a steering system can be configured to control steering of the vehicle. In some implementations, the vehicle controller can control the throttle system, the brake system, the steering system, and/or other systems in order to cause the vehicle to travel in accordance with the motion plan.

The sensors of the autonomous vehicle can be placed on the various portions of the autonomous vehicle. For example, one or more first sensors can be located onboard a first portion (e.g., the cab portion) of the autonomous vehicle and one or more second sensors can be located onboard a second portion (e.g., the chassis portion) of the autonomous vehicle. As such, the sensors can be subjected to the independent movements of that respective vehicle portion.

For example, in some implementations, an IMU can be positioned on the cab portion of the autonomous vehicle. For example, the IMU can be positioned on top of the cab portion adjacent to one or more sensors, such as one or more LIDAR sensors. The IMU can include one or more accelerometers, gyroscopes, or other devices configured to measure an acceleration of the autonomous vehicle. In some implementations, the IMU can measure acceleration in three-dimensions, such as about the roll axis, about the pitch axis, and in the vertical direction. Data obtained by the IMU can be provided to a computing system to determine a pose of the autonomous vehicle.

Similarly, in some implementations, one or more wheel odometry sensors can be included on a chassis portion of the autonomous vehicle. For example, the chassis can generally include a frame, axles, wheels, suspension components, and other components. One or more wheel odometry sensors can be configured to obtain measurements of a rotation of a respective wheel. Data obtained by the wheel odometry sensors can be used to determine a position, a velocity, and/or an acceleration of the vehicle. For example, the data obtained by the wheel odometry sensors can be provided to a state estimator to determine the pose of the autonomous vehicle.

As noted, in some implementations, the state estimator can receive inputs from a plurality of sensors, such as one or more displacement sensors, IMU(s), wheel odometry sensor(s), or other sensors. In some implementations, the state estimator can determine the pose by first determining the orientation of the first portion relative to the second portion, thereby determining the orientation of the various sensors on the first portion and/or the second portion, and then determining the pose based on the orientation.

In some implementations, the computing system can further determine a motion plan for the autonomous vehicle based at least in part on the pose. For example, the pose can describe the position and orientation of the autonomous vehicle in the surrounding environment, and the computing system can generate the motion plan to determine how the autonomous vehicle will travel within the surrounding environment.

In some implementations, the computing system can further cause the autonomous vehicle to initiate travel in accordance with at least a portion of the motion plan. For example, the computing system and/or a vehicle controller can control a throttle system, brake system, steering system, and/or another vehicle system to cause the autonomous vehicle to travel within the surrounding environment according to the motion plan.

The systems and methods described herein may provide a number of technical effects and benefits. For example, the systems and methods provide for more accurate autonomous operation. For example, as described herein, sensor data can be used to detect objects within the vehicle's surroundings and to help predict the motion of such objects, which is ultimately used for vehicle motion planning. By accounting for displacement of one portion of a vehicle relative to another, and by extension, the displacement of the sensors positioned on those portions, an orientation of the various portions and the associated sensors of the vehicle can be determined. Further, this orientation can be used to determine a more accurate pose of the vehicle. Thus, the systems and methods described herein can allow for an autonomous vehicle to more accurately determine the pose of the vehicle in the surrounding environment, such as the vehicle's position and orientation within the surrounding environment, and in turn allow for improved motion planning and vehicle control functions of the autonomous vehicle.

Thus, displacement related sensor mismatch can lead to less accurate object detection, object motion prediction, and vehicle motion planning. The movement associated with a first portion of a vehicle relative to the second portion can cause the sensor data captured by the sensors mounted on that vehicle portion (e.g., cab portion, etc.) to be misinterpreted by the vehicle autonomy system. The systems and methods described herein provide a solution to address potential sensor mismatch in real-time (or at least near real-time), as the errors may arise due to vehicle movements. Thus, the systems and methods of the present disclosure can improve autonomous vehicle operation by compensating for displacement related sensor mismatch.

The systems and methods of the present disclosure can also increase the safety of autonomous vehicle operation. For example, by more accurately determining the pose of the autonomous vehicle, the autonomous vehicle can more accurately plan and travel within the surrounding environment of the autonomous vehicle. For example, by helping to improve the autonomous vehicle's understanding of its position and orientation within the surrounding environment, the autonomous vehicle can more accurately interpret the surrounding environment (e.g., the ground, obstacles, etc.) and therefore plan and move within the environment. This can help to ensure that the autonomous vehicle responds to the surrounding environment in a more consistent, predictable manner.

The systems and methods of the present disclosure also provide an improvement to vehicle computing technology, such as autonomous vehicle computing technology. For instance, the systems and methods enable the vehicle technology to obtain data indicative of displacement of a first portion of a vehicle relative to a second portion from one or more displacement sensors. For example, the systems and methods enable one or more on-board computing device(s) to obtain data from one or more displacement sensors, such as one or more linear encoders configured to obtain measurements of a displacement of the first portion relative to the second portion. The computing device(s) can determine an orientation of the first portion relative to the second portion about a pitch axis or a roll axis based at least in part on the data indicative of the displacement. For example, the computing device(s) can model the movement of the first portion relative to the second portion to determine the orientation of the first portion relative to the second portion. In this way, the systems and methods disclosed herein enable the autonomous vehicle to more accurately determine the pose of the autonomous vehicle, thereby more allowing for more efficient use of sensor data collected by the autonomous vehicle. Thus, the systems and methods of the present disclosure can improve the accuracy of vehicle sensor technology, as well as the efficacy of the vehicle's autonomy system.

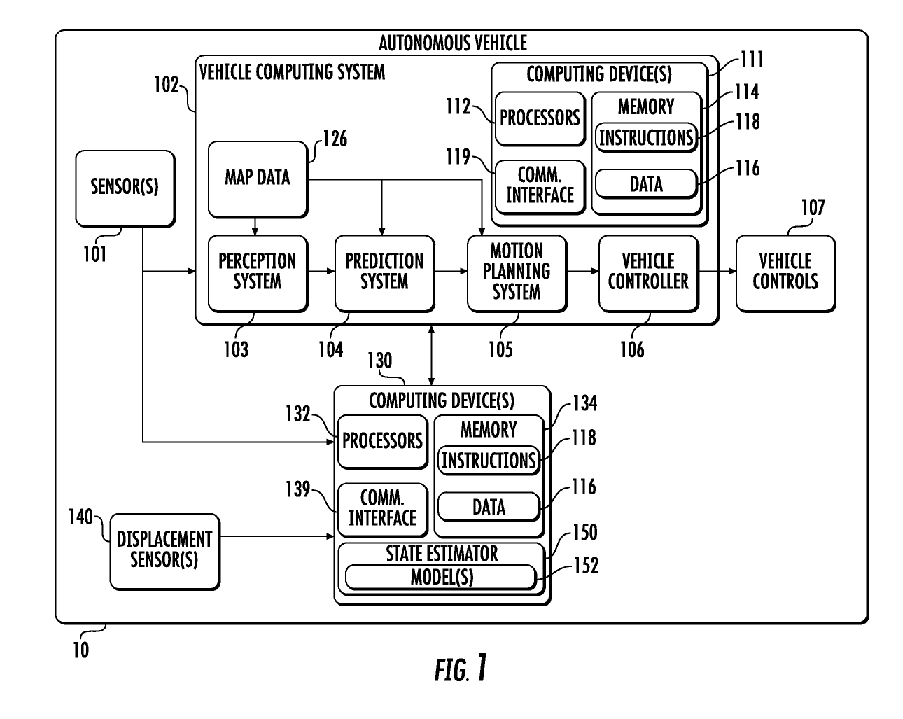

With reference now to the FIGS., example aspects of the present disclosure will be discussed in further detail. FIG. 1 depicts a block diagram of an example vehicle 10 according to example aspects of the present disclosure. In some implementations, the vehicle 10 can be an autonomous vehicle 10, and can include one or more sensors 101, a vehicle computing system 102, and one or more vehicle controls 107. The vehicle 10 incorporating the vehicle computing system 102 can be a ground-based autonomous vehicle (e.g., car, truck, bus), an air-based autonomous vehicle (e.g., airplane, drone, helicopter, or other aircraft), or other types of vehicles (e.g., watercraft). The vehicle 10 can be an autonomous vehicle that can drive, navigate, operate, etc. with minimal and/or no interaction from a human driver. For example, the vehicle 10 can operate semi-autonomously with some interaction from a human driver present in the vehicle. The vehicle 10 can be configured to operate in a fully autonomous manner (e.g., self-driving manner) such that the vehicle 10 can drive, navigate, operate, etc. with no interaction from a human driver.

For example, the vehicle computing system 102 can assist in controlling the vehicle 10. In particular, the vehicle computing system 102 can receive sensor data from the one or more sensors 101, attempt to comprehend the surrounding environment by performing various processing techniques on data collected by the sensors 101, and generate an appropriate motion plan through such surrounding environment. The vehicle computing system 102 can control the one or more vehicle controls 107 to operate the vehicle 10 according to the motion plan.

The vehicle computing system 102 can include one or more computing devices 111. The one or more computing devices 111 can include one or more processors 112 and one or more memory 114. The one or more processors 112 can be any suitable processing device (e.g., a processor core, a microprocessor, an ASIC, a FPGA, a computing device, a microcontroller, etc.) and can be one processor or a plurality of processors that are operatively connected. The one or more memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which can be executed by the processor 112 to cause vehicle computing system 102 to perform operations. The one or more computing devices 111 can also include a communication interface 119, which can allow the one or more computing devices 111 to communicate with other components of the vehicle 10 or external computing systems, such as via one or more wired or wireless networks.

As illustrated in FIG. 1, the vehicle computing system 102 can include a perception system 103, a prediction system 104, and a motion planning system 105 that cooperate to perceive the surrounding environment of the vehicle 10 and determine a motion plan for controlling the motion of the vehicle 10 accordingly. In some implementations, the perception system 103, the prediction system 104, the motion planning system 105 can be included in or otherwise a part of a vehicle autonomy system. As used herein, the term “vehicle autonomy system” refers to a system configured to control the movement of an autonomous vehicle.

In particular, in some implementations, the perception system 103 can receive sensor data from the one or more sensors 101 that are coupled to or otherwise included within the vehicle 10. As examples, the one or more sensors 101 can include a Light Detection and Ranging (LIDAR) system, a Radio Detection and Ranging (RADAR) system, one or more cameras (e.g., visible spectrum cameras, infrared cameras, etc.), and/or other sensors. The sensor data can include information that describes the location of objects within the surrounding environment of the vehicle 10.

As one example, for a LIDAR system, the sensor data can include the location (e.g., in three-dimensional space relative to the LIDAR system) of a number of points that correspond to objects that have reflected a ranging laser. For example, a LIDAR system can measure distances by measuring the Time of Flight (TOF) that it takes a short laser pulse to travel from the sensor to an object and back, calculating the distance from the known speed of light.

As another example, for a RADAR system, the sensor data can include the location (e.g., in three-dimensional space relative to the RADAR system) of a number of points that correspond to objects that have reflected a ranging radio wave. For example, radio waves (e.g., pulsed or continuous) transmitted by the RADAR system can reflect off an object and return to a receiver of the RADAR system, giving information about the object's location and speed. Thus, a RADAR system can provide useful information about the current speed of an object.

As yet another example, for one or more cameras, various processing techniques (e.g., range imaging techniques such as, for example, structure from motion, structured light, stereo triangulation, and/or other techniques) can be performed to identify the location (e.g., in three-dimensional space relative to the one or more cameras) of a number of points that correspond to objects that are depicted in imagery captured by the one or more cameras. Other sensor systems can identify the location of points that correspond to objects as well.

As another example, the one or more sensors 101 can include a positioning system. The positioning system can determine a current position of the vehicle 10. The positioning system can be any device or circuitry for analyzing the position of the vehicle 10. For example, the positioning system can determine a position by using one or more of inertial sensors (e.g., IMUs), a satellite positioning system, based on IP address, by using triangulation and/or proximity to network access points or other network components (e.g., cellular towers, WiFi access points, etc.) and/or other suitable techniques. The position of the vehicle 10 can be used by various systems of the vehicle computing system 102.

Thus, the one or more sensors 101 can be used to collect sensor data that includes information that describes the location (e.g., in three-dimensional space relative to the vehicle 10) of points that correspond to objects within the surrounding environment of the vehicle 10. In some implementations, the sensors 101 can be located at various different locations on the vehicle 10. As an example, in some implementations, one or more cameras and/or LIDAR sensors can be located in a pod or other structure that is mounted on a roof of the vehicle 10 while one or more RADAR sensors can be located in or behind the front and/or rear bumper(s) or body panel(s) of the vehicle 10. As another example, camera(s) can be located at the front or rear bumper(s) of the vehicle 10 as well. Other locations can be used as well.

In addition to the sensor data, the perception system 103 can retrieve or otherwise obtain map data 126 that provides detailed information about the surrounding environment of the vehicle 10. The map data 126 can provide information regarding: the identity and location of different travelways (e.g., roadways), road segments, buildings, or other items or objects (e.g., lampposts, crosswalks, curbing, etc.); the location and directions of traffic lanes (e.g., the location and direction of a parking lane, a turning lane, a bicycle lane, or other lanes within a particular roadway or other travelway); traffic control data (e.g., the location and instructions of signage, traffic lights, or other traffic control devices); and/or any other map data that provides information that assists the vehicle computing system 102 in comprehending and perceiving its surrounding environment and its relationship thereto.

The perception system 103 can identify one or more objects that are proximate to the vehicle 10 based on sensor data received from the one or more sensors 101 and/or the map data 126. In particular, in some implementations, the perception system 103 can determine, for each object, state data that describes a current state of such object (also referred to as features of the object). As examples, the state data for each object can describe an estimate of the object's: current location (also referred to as position); current speed (also referred to as velocity); current acceleration; current heading; current orientation; size/shape/footprint (e.g., as represented by a bounding shape such as a bounding polygon or polyhedron); type/class (e.g., vehicle versus pedestrian versus bicycle versus other); yaw rate; distance from the vehicle 10; minimum path to interaction with the vehicle 10; minimum time duration to interaction with the vehicle 10; and/or other state information.

In some implementations, the perception system 103 can determine state data for each object over a number of iterations. In particular, the perception system 103 can update the state data for each object at each iteration. Thus, the perception system 103 can detect and track objects (e.g., vehicles) that are proximate to the vehicle 10 over time.

The prediction system 104 can receive the state data from the perception system 103 and predict one or more future locations for each object based on such state data. For example, the prediction system 104 can predict where each object will be located within the next 5 seconds, 10 seconds, 20 seconds, etc. As one example, an object can be predicted to adhere to its current trajectory according to its current speed. As another example, other, more sophisticated prediction techniques or modeling can be used.

The prediction system 104 can create prediction data associated with each of the respective one or more objects within the surrounding environment of the vehicle 10. The prediction data can be indicative of one or more predicted future locations of each respective object. For example, the prediction data can be indicative of a predicted trajectory (e.g., predicted path) of at least one object within the surrounding environment of the vehicle 10. For example, the predicted trajectory (e.g., path) can indicate a path along which the respective object is predicted to travel over time (and/or the speed at which the object is predicted to travel along the predicted path).

For example, in some implementations, the prediction system 104 can be a goal-oriented prediction system that generates one or more potential goals, selects one or more of the most likely potential goals, and develops one or more trajectories by which the object can achieve the one or more selected goals. For example, the prediction system 104 can include a scenario generation system that generates and/or scores the one or more goals for an object and a scenario development system that determines the one or more trajectories by which the object can achieve the goals. In some implementations, the prediction system 104 can include a machine-learned goal-scoring model, a machine-learned trajectory development model, and/or other machine-learned models.

In some implementations, the predictions system 104 can use state data indicative of an object type or classification to predict a trajectory for the object. As an example, the prediction system 104 can use state data provided by the perception system 103 to determine that particular object (e.g., an object classified as a vehicle) approaching an intersection and maneuvering into a left-turn lane intends to turn left. In such a situation, the prediction system 104 can predict a trajectory (e.g., path) corresponding to a left-turn for the vehicle such that the vehicle turns left at the intersection. Similarly, the prediction system 104 can determine predicted trajectories for other objects, such as bicycles, pedestrians, parked vehicles, etc. The prediction system 104 can provide the predicted trajectories associated with the object(s) to the motion planning system 105.

The motion planning system 105 can determine a motion plan for the vehicle 10 based at least in part on the predicted trajectories associated with the objects within the surrounding environment of the vehicle and/or the state data for the objects provided by the perception system 103. Stated differently, given information about the current locations of objects and/or predicted trajectories of objects within the surrounding environment of the vehicle 10, the motion planning system 105 can determine a motion plan for the vehicle 10 that best navigates the vehicle 10 relative to the objects at such locations and their predicted trajectories.

In some implementations, the motion planning system 105 can evaluate one or more cost functions and/or one or more reward functions for each of one or more candidate motion plans for the vehicle 10. For example, the cost function(s) can describe a cost (e.g., over time) of adhering to a particular candidate motion plan while the reward function(s) can describe a reward for adhering to the particular candidate motion plan. For example, the reward can be of opposite sign to the cost.

Thus, given information about the current locations and/or predicted future locations/trajectories of objects, the motion planning system 105 can determine a total cost (e.g., a sum of the cost(s) and/or reward(s) provided by the cost function(s) and/or reward function(s)) of adhering to a particular candidate pathway. The motion planning system 105 can select or determine a motion plan for the vehicle 10 based at least in part on the cost function(s) and the reward function(s). For example, the motion plan that minimizes the total cost can be selected or otherwise determined. The motion plan can be, for example, a path along which the vehicle 10 will travel in one or more forthcoming time periods. The motion planning system 105 can provide the selected motion plan to a vehicle controller 106 that controls one or more vehicle controls 107 (e.g., actuators or other devices that control gas flow, steering, braking, etc.) to execute the selected motion plan. In some implementations, the motion planning system 105 can be configured to iteratively update the motion plan for the vehicle 10 as new sensor data is obtained from one or more sensors 101. For example, as new sensor data is obtained from one or more sensors 101, the sensor data can be analyzed by the perception system 103, the prediction system 104, and the motion planning system 105 to determine the motion plan.

Each of the perception system 103, the prediction system 104, and the motion planning system 105 can be included in or otherwise a part of a vehicle autonomy system configured to determine a motion plan based at least in part on data obtained from one or more sensors 101. For example, data obtained by one or more sensors 101 can be analyzed by each of the perception system 103, the prediction system 104, and the motion planning system 105 in a consecutive fashion in order to develop the motion plan. While FIG. 1 depicts elements suitable for use in a vehicle autonomy system according to example aspects of the present disclosure, one of ordinary skill in the art will recognize that other vehicle autonomy systems can be configured to determine a motion plan for a vehicle 10 based on sensor data.

Each of the perception system 103, the prediction system 104, the motion planning system 105, and the vehicle controller 106 can include computer logic utilized to provide desired functionality. In some implementations, each of the perception system 103, the prediction system 104, the motion planning system 105, and the vehicle controller 106 can be implemented in hardware, firmware, and/or software controlling a general purpose processor. For example, in some implementations, each of the perception system 103, the prediction system 104, the motion planning system 105, and the vehicle controller 106 includes program files stored on a storage device, loaded into a memory and executed by one or more processors. In other implementations, each of the perception system 103, the prediction system 104, the motion planning system 105, and the vehicle controller 106 includes one or more sets of computer-executable instructions that are stored in a tangible computer-readable storage medium such as RAM hard disk or optical or magnetic media.

The vehicle 10 can further include one or more displacement sensors 140. The one or more displacement sensors 140 can be configured to obtain measurements of a displacement of a first portion of the vehicle 10 relative to the second portion of the vehicle 10. In some implementations, a displacement sensor 140 can be a linear displacement sensor. For example, in some implementations, the displacement sensor 140 can be a linear encoder. In other implementations, the one or more displacement sensors 140 can include one or more lasers or other sensors configured to obtain displacement measurements. The one or more displacement sensors can be configured to obtain measurements of a displacement of a first portion of a vehicle 10 relative to a second portion.

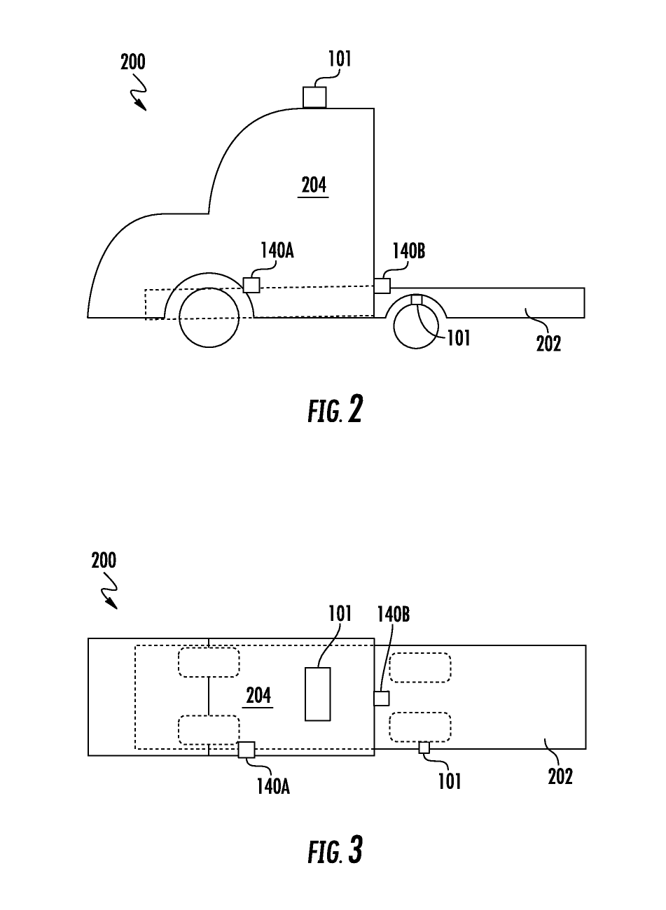

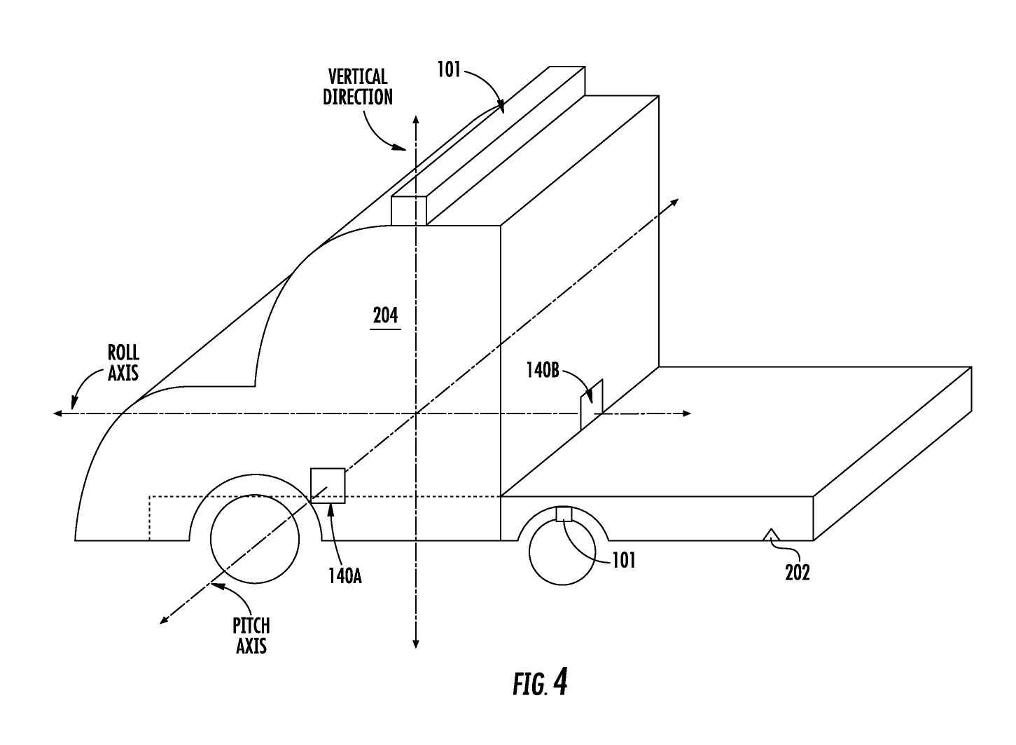

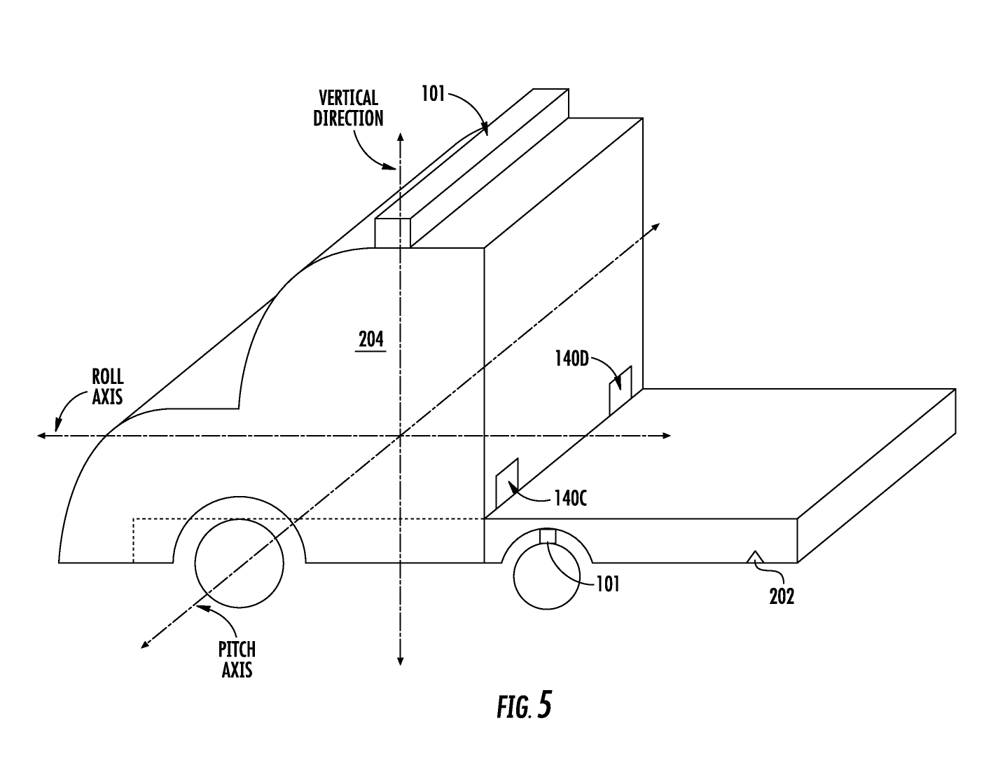

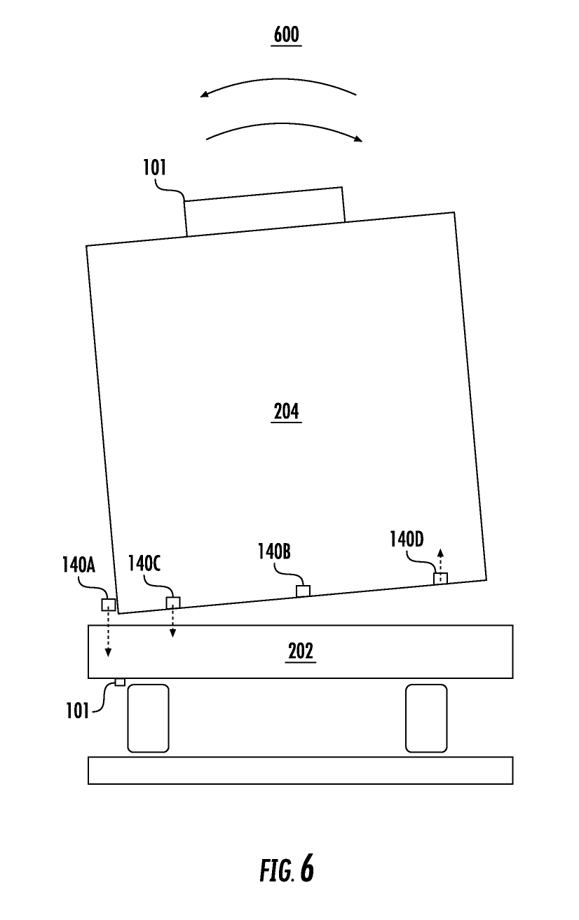

For example, referring now to FIGS. 2-5, an example vehicle 200 according to example embodiments of the present disclosure is depicted. For example, FIG. 2 depicts a side view of an example vehicle 200, FIG. 3 depicts a top down view of the vehicle 200, and FIGS. 4 and 5 depict perspective views of the vehicle 200. The vehicle 10 of FIG. 1 can be the vehicle 200 or can be other types of vehicles.

The vehicle 200 is an autonomous truck that includes a first portion and a second portion (e.g., different than the first portion). The first portion and the second portion can be configured to move at least partially independently from one another. For example, one portion can experience a movement (e.g., a pitch, yaw, roll, other movement) while the other portion does not. As examples, the first and the second portions can be non-rigidly coupled; flexibly coupled; jointedly coupled; pivotably coupled; coupled via a ball and socket connection; and/or coupled via other forms of coupling that allow at least partial independent movement respective to each other. By way of example, the first portion can be a chassis portion 202 and the second portion can be a cab portion 204, or vice versa, that are affixed to one another. The cab portion 204 can move at least partially independently from the chassis portion 202 due to a suspension system associated with the cab portion 204 (e.g., air suspension, spring suspension, etc.).

The vehicle 200 can include one or more sensors 100 positioned on the vehicle 200. For example, as shown in FIGS. 2 and 3, a first sensor 101 is positioned on top of a cab portion 204 and a second sensor 101 is positioned on a chassis portion 202. In other implementations, the one or more sensors 101 can be positioned at various positions on the vehicle 200, such as other positions on a cab portion 204 or a chassis portion 202, as disclosed herein. In some implementations, the sensor 101 on the cab portion 202 can be an IMU or LIDAR sensor, and the sensor 101 on the chassis portion 202 can be a wheel odometry sensor.

The relative movements of the first portion of the vehicle 200 to the second portion of the vehicle 200 can cause displacement-related sensor mismatch. For example, as a vehicle 200 travels over a pothole, the cab portion 204 of a vehicle 200 may pitch back and forth or roll side to side relative to the chassis portion 202. Further, this relative movement of the two portions can cause the vehicle autonomy system to incorrectly interpret data from one or more sensors 101 of the vehicle 200. For example, in some situations, the vehicle autonomy system may not account for the relative movement of the two portions, and may therefore incorrectly interpret data from one or more sensors 101.

For example, as the cab portion pitches and/or rolls, a LIDAR sensor positioned on top of the cab portion 204 may send light signals which reflect off of the travelway (e.g., road surface) on which the autonomous vehicle 10 is travelling. In some situations, the reflected LIDAR signals may be misinterpreted by the vehicle autonomy system as an obstacle in front of the autonomous vehicle 10. In response, the vehicle autonomy system may control the autonomous vehicle 10 to a stop in order to avoid colliding with the misinterpreted roadway obstacle. The systems and methods of the present disclosure, however, can compensate for such displacement.

For example, the vehicle 200 can also include one or more displacement sensors 140 configured to obtain measurements of the displacement of the first portion of the vehicle 200 relative to the second portion of the vehicle 200.

For example, as shown in FIGS. 2 and 3, a first displacement sensor 140A is positioned on a driver side of the first portion (e.g., cab portion 204) of the vehicle, and a second displacement sensor 140B is positioned on a rear side of the first portion (e.g., cab portion 204). Each displacement sensor 140 can obtain measurements of a displacement of the first portion (e.g., cab portion 204) relative to the second portion (chassis portion 202).

For example, as shown in FIG. 4, the vehicle 200 can be associated with a pitch axis, a roll axis, and a vertical direction. For example, the roll axis and the pitch axis can be perpendicular to one another, and generally define a plane parallel to the ground on which the vehicle 200 travels. The vertical direction can be generally perpendicular to the plane defined by the pitch axis and roll axis. In some implementations, the cab portion 204 can move relative to the chassis portion 202 about the pitch axis and/or the roll axis (e.g., one portion experiences a pitch, roll, etc. movement while the other does not). In some implementations, the one or more displacement sensors 140 can be configured to obtain displacement measurements along the vertical direction as the cab portion 204 moves relative to the chassis portion 202. For example, in some implementations, the displacement sensors can measure a displacement, which can include a component along the vertical direction.

For example, in some implementations, the one or more displacement sensors 140 can include a displacement sensor 140 associated with the roll axis. For example, as shown in FIG. 4, the displacement sensor 140A is located at a position remote from the roll axis (e.g., at a position not along the roll axis). Further, the displacement sensor 140A can be configured to measure a displacement about the roll axis. In some implementations, the displacement sensor 140A can be positioned along the pitch axis, as shown. In other implementations, the displacement sensor 140A can be positioned at any position remote from the roll axis. In some implementations, the displacement sensor 140A can be configured to measure a displacement along the vertical direction (and/or a vertical component of a displacement). For example, as the first portion (e.g., cab portion 204) of the vehicle 200 moves about the roll axis (e.g., rolls from side to side), the displacement sensor 104A can be configured to measure a displacement of the first portion (e.g., cab portion 204) relative to the second portion (e.g., chassis portion 202) along the vertical direction. In some implementations, the displacement sensor 140B can be configured to measure a displacement along the plane defined by the pitch and roll axes.

In some implementations, the one or more displacement sensors 140 can include a displacement sensor 140B associated with the pitch axis. For example, as shown in FIG. 4, the displacement sensor 140B can be located at a position remote from the pitch axis (e.g., at a position not along the pitch axis). Further, the displacement sensor 140B can be configured to measure a displacement about the pitch axis. In some implementations, the displacement sensor 140B can be positioned along the roll axis, as shown. In other implementations, the displacement sensor 140B can be positioned at any position remote from the pitch axis. In some implementations, the displacement sensor 140B can be configured to measure a displacement along the vertical direction (and/or vertical component of a displacement). For example, as the first portion (e.g., cab portion 204) of the vehicle 200 moves about the pitch axis (e.g., pitches from front to back and vice-versa), the displacement sensor 140B can be configured to measure a displacement of the first portion (e.g., cab portion 2040 relative to the second portion (e.g., chassis portion 202) along the vertical direction. In some implementations, the displacement sensor 140B can be configured to measure a displacement along the plane defined by the pitch and roll axes.

Referring now to FIG. 5, in some implementations, the one or more displacement sensors can include a first displacement sensor 140C and a second displacement sensor 140D. In some implementations, the first displacement sensor 140C and the second displacement sensor 140D can both be associated with the pitch axis and/or the roll axis. For example, the first displacement sensor 140C and the second displacement sensor 140D can both be located at a position remote from both the pitch axis and the roll axis (e.g., at a position not along the pitch axis or the roll axis). For example, in some implementations, the first displacement sensor 140C and the second displacement sensor 140D can be configured to measure a displacement along the vertical direction (and/or a vertical component of a displacement) when the vehicle 200 pitches and/or rolls. For example, as the first portion (e.g., cab portion 204) of the vehicle 200 moves about the pitch axis (e.g., pitches from front to back and vice versa) and/or moves about the roll axis (e.g., rolls from side to side), the first displacement sensor 140C and the second displacement sensor 140D can be configured to each measure a displacement along the vertical direction. In some implementations, the displacement sensors 140 A/B can be configured to measure a displacement along the plane defined by the pitch and roll axes. Additional displacement sensors 140 can similarly be included in a vehicle 200.

Referring back to FIG. 1, the one or more displacement sensors 140 of the vehicle 10 can be configured to provide data indicative of the displacement measurements obtained by the sensors 140 to one or more computing devices 111/130 and/or a computing system 102 of the vehicle 10.

For example, in some implementations, the vehicle 10 can further include one or more computing device(s) 130. In some implementations, the computing device(s) 130 can be incorporated in or otherwise a part of a vehicle computing system 102. In some implementations, the computing device(s) 130 can be one or more separate computing devices 130 separate from the vehicle computing system 102, and can be configured to communicate with the vehicle computing system 102, such as via one or more wired and/or wireless connections. For example, as shown in FIG. 1, the computing device(s) 130 are separate computing device(s) 130 from the computing device(s) 111; however, in some implementations, the computing device(s) 130 can be the computing device(s) 111 or otherwise incorporated into a vehicle computing system 102.

The one or more computing devices 130 can include one or more processors 132 and one or more memory 134. The one or more processors 132 can be any suitable processing device (e.g., a processor core, a microprocessor, an ASIC, a FPGA, a computing device, a microcontroller, etc.) and can be one processor or a plurality of processors that are operatively connected. The one or more memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which can be executed by the processor 132 to cause the computing device(s) 130 to perform operations. The one or more computing devices 130 can also include a communication interface 119, which can allow the one or more computing devices 130 to communicate with other components of the vehicle 10 or external computing systems, such as via one or more wired or wireless networks.

According to example aspects of the present disclosure, a computing system, such as a computing system comprising one or more computing devices 130, can be configured to obtain data indicative of displacement of the first portion of a vehicle 10 relative to the second portion from the one or more displacement sensors 140. For example, the one or more displacement sensors 140 can be configured to provide one or more signals to the computing device 130, which can receive the signals, such as via one or more wired or wireless connections.

The computing device 130 can further be configured to determine an orientation of the first portion (e.g., cab portion 204) relative to the second portion (e.g., chassis portion 202) about the pitch axis or the roll axis based at least in part on the data indicative of the displacement. For example, known relationships between the position of the one or more displacement sensors 140 and a roll axis and/or pitch axis can be used to determine an orientation of the first portion relative to the second portion. Further, the computing device 130, either alone or in conjunction with other components of the vehicle 10, can be configured to compensate for such displacement using the orientation of the first portion relative to the second portion.

For example, in some implementations, each of the first portion and the second portion can be represented by a plane, which can generally be parallel to one another at rest. However, as the first portion (e.g., cab portion 204) of the vehicle 200 pitches or rolls, the plane representing the first portion can pitch or roll with respect to the second plane (e.g., chassis portion 202). The orientation of the first portion to the second portion can generally describe the pitch and/or roll of the first portion relative to the second portion.

In some implementations, a model can be used by a computing device 130 to model the movement of the first portion relative to the second portion, as described in greater detail below. In some implementations, the orientation of the first portion relative to the second portion can be determined by a computing device 130 using one or more mathematical relationships, such as, for example, the Pythagorean Theorem.

In some implementations, the computing device 130 can be configured to determine an orientation of the first portion relative to the second portion about the roll axis by obtaining data from a displacement sensor associated with the roll axis. For example, as shown in FIG. 4, in some implementations, a displacement sensor 140A can be positioned remote from the roll axis, and can be configured to measure a displacement along the vertical direction. The computing device 130 can be configured to receive data indicative of a displacement from the displacement sensor, and using known relationships and/or a model, determine the orientation of the first portion (e.g., cab portion 204) relative to the second portion (e.g., chassis portion 202) about the roll axis from the data.

Similarly, in some implementations, the computing device 130 can be configured to determine an orientation of the first portion relative to the second portion about the pitch axis by obtaining data from a displacement sensor associated with the pitch axis. For example, as shown in FIG. 4, in some implementations a displacement sensor 140B can be positioned remote from the pitch axis, and can be configured to measure a displacement along the vertical direction. The computing device 130 can be configured to receive data indicative of a displacement from the displacement sensor 140B, and using known relationships and/or a model, determine the orientation of the first portion (e.g., cab portion 204) relative to the second portion (e.g., chassis portion 202) about the pitch axis from the data.

In some implementations, the computing device 130 can be configured to determine the orientation of the first portion relative to the second portion based at least in part on a comparison of a first displacement measurement from a first displacement sensor and a second displacement measurement from a second displacement sensor.

For example, as shown in FIG. 5, in some implementations a first displacement sensor 140C and a second displacement sensor 140D can both be positioned remote from the pitch axis and the roll axis. For example, in some implementations, the first displacement sensor 140C and the second displacement sensor 140D can be positioned on the same side of a cab portion 204 and approximately equidistant from the pitch axis, and on opposite sides of the roll axis. When both displacement sensors 140C/D measure an approximately equal vertical displacement in the same direction, the computing device 130 can be configured to determine that the first portion (e.g., cab portion 204) has pitched. When the first displacement sensor 140C measures no vertical displacement or a negative vertical displacement and the second displacement sensor 140D measures a positive vertical displacement, the computing device 130 can be configured to determine that the first portion (e.g., cab portion 204) has rolled. Similarly, the computing device 130 can be configured to determine when the first portion has pitched and rolled with respect to the second portion by comparing measurements from the first displacement sensor 140C and the second displacement sensor 140D.

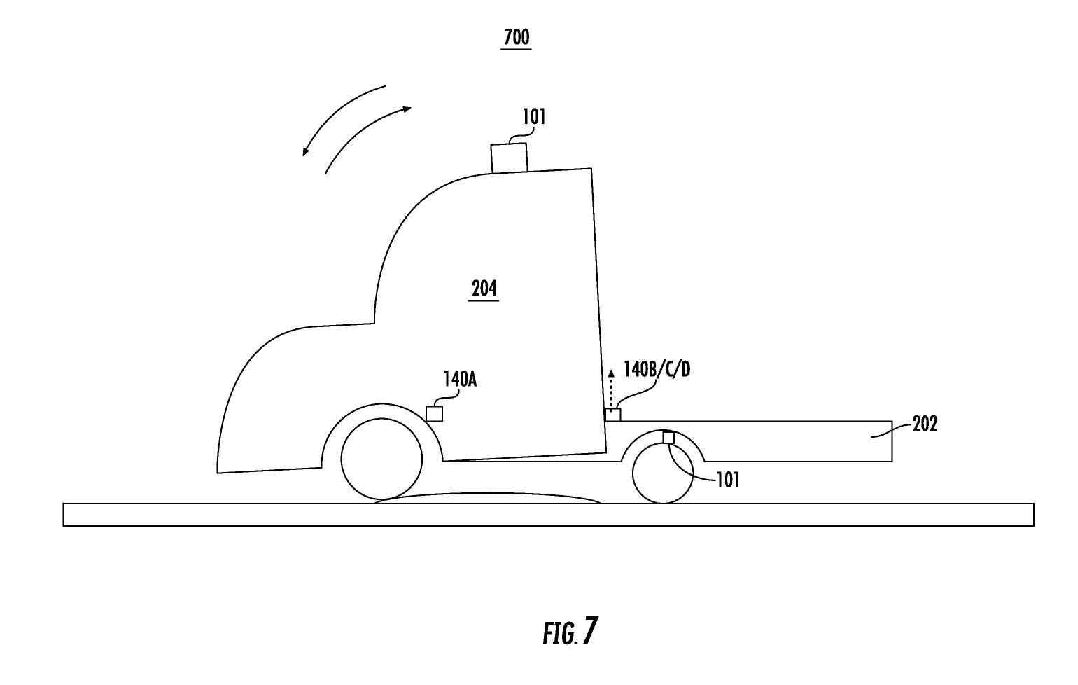

For example, referring now to FIG. 6, an example movement of a first portion of a vehicle 200 with respect to a second portion and corresponding displacement sensors 140 is shown. The first portion can be a cab portion 204 mounted atop a chassis portion 202, and the cab portion 204 can be configured to pitch and/or roll with respect to the chassis portion 202.

As shown, the cab portion 204 has rolled with respect to the chassis portion 202. Each of the displacement sensors 140 has a corresponding dashed arrow depicting a relative displacement measurement for each sensor 140. For example, as shown, a displacement sensor 140A associated with a roll axis of the vehicle 200 is depicted as measuring the greatest relative displacement downwards in the vertical direction. However, a displacement sensor 140B associated with a pitch axis is not measuring any displacement, as it is positioned generally along the roll axis. In some implementations, the computing device 130 can be configured to obtain a measurement from a displacement sensor 140 associated with the roll axis, such as from displacement sensor 140A, and determine that the first portion (e.g., cab portion 204) has rolled with respect to the second portion (e.g., chassis portion 202) based on the measurement.

Similarly, in some implementations, a first displacement sensor 140C and a second displacement sensor 140D can both obtain displacement measurements, and the computing device 130 can be configured to determine an orientation of the first portion relative to the second portion based on a comparison of the measurements from the two displacement sensors 140C/D. For example, as shown, a first displacement sensor 140C is measuring a downward displacement in the vertical direction, while a second displacement sensor 140D is measuring an approximately equal upward displacement in the vertical direction. The computing device 130 can be configured to obtain the measurements from the two displacement sensors 140C/D and determine that the first portion (e.g., cab portion 204) has rolled with respect to the second portion (e.g., chassis portion 202) based at least in part on a comparison of the two measurements. For example, measurements in opposite directions can indicate to the computing device 130 that the first portion has rolled to one side (e.g., a left/driver side) relative to the second portion.

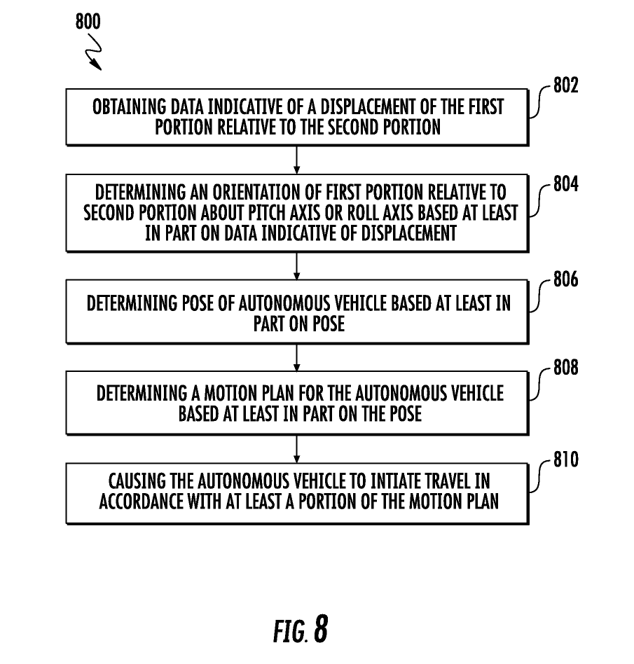

Similarly, referring now to FIG. 7, another example movement of a first portion of a vehicle 200 with respect to a second portion and corresponding displacement sensors 140 is shown. The first portion can be a cab portion 204 mounted atop a chassis portion 202, and the cab portion 204 can be configured to pitch and/or roll with respect to the chassis portion 202.

As shown, the cab portion 204 has pitched with respect to the chassis portion 202. Each of the displacement sensors 140 has a corresponding dashed arrow depicting a relative displacement measurement for each sensor. For example, as shown, a displacement sensor 140A associated with a roll axis of the vehicle 200 is depicted as not measuring a displacement in the vertical direction. However, displacement sensor 140B associated with the pitch axis is measuring a displacement upwards along the vertical direction. In some implementations, the computing device 130 can be configured to obtain a measurement from a displacement sensor 140 associated with the pitch axis, such as from displacement sensor 140B, and determine that the first portion (e.g., cab portion 204) has pitched with respect to the second portion (e.g., chassis portion 202) based on the measurement.

Similarly, in some implementations, a first displacement sensor 140C and a second displacement sensor 140D can both obtain displacement measurements, and the computing device 130 can be configured to determine an orientation of the first portion relative to the second portion based on a comparison of the measurements from the two displacement sensors 140C/D. For example, as shown, both first displacement sensor 140C and second displacement sensor 140D are both measuring approximately equal displacement upwards along the vertical direction. The computing device 130 can be configured to obtain the measurements from the two displacement sensors 140C/D and determine that the first portion (e.g., cab portion 204) has pitched with respect to the second portion (e.g., chassis portion 202) based at least in part on a comparison of the two measurements. For example, measurements in the same direction can indicate to the computing device 130 that the first portion has pitched (e.g., forward) relative to the second portion.

The displacement sensor configurations, example movements, and corresponding displacement sensor measurements depicted in FIGS. 6 and 7 are for illustrative purposes. One of ordinary skill in the art will recognize that any number of displacement sensors 140 and/or configurations can be included in a vehicle 200, and further, that a computing device 111/130 can be configured to obtain measurements from such displacement sensors 140 to determine an orientation of the first portion of the vehicle 10 relative to the second portion.

For example, in some implementations in which a first displacement sensor 140C and a second displacement sensor 140D in which both are remote from the pitch axis and roll axis, a third displacement sensor, such as a displacement sensor 140A can be positioned remote from the first displacement sensor 140C and the second displacement sensor 140D. Further, measurements from the third displacement sensor (e.g., 140A) can be used by the computing device 130. For example, the computing device 111/130 can compare measurements from the first displacement sensor 140C (or the second displacement sensor 140D) and the third displacement sensor (e.g., 140A) to determine the orientation of the first portion relative to the second portion.

Referring again to FIG. 1, in some implementations, the computing device 130 can further determine a pose of the vehicle 10 based at least in part on the orientation of the first portion relative to the second portion. The pose can generally describe the position and/or orientation of the vehicle 10 in the surrounding environment. For example, in some implementations, the pose can include a roll, a pitch, or a yaw of the vehicle 10, or a position of the vehicle 10 in a surrounding environment of the vehicle 10. For example, once the orientation of the first portion relative to the second portion has been determined, the pose of the vehicle 10 can be determined using data from sensors 101 on both the first portion and the second portion.

For example, in some implementations, a computing device 130 can include a state estimator 150. In some implementations, the state estimator 150 can include a Kalman filter configured to receive a plurality of inputs and determine a state of the vehicle 10 based on the plurality of inputs. The state of the vehicle 10 can include a pose of the vehicle 10, which can generally describe where the vehicle 10 is located and how the vehicle 10 is oriented with respect to the surrounding environment. For example, the state estimator 150 can receive data from LIDAR sensors, accelerometers (e.g., an IMU), wheel odometry sensors, map data, GPS data, and/or other data to determine the pose of the vehicle 10.

In some implementations, the state estimator 150 can include one or more models 152 configured to model the first portion (e.g., cab portion 204) of the vehicle 10 moving about a pitch axis or a roll axis with respect to the second portion (e.g., chassis). In some implementations, the model(s) 152 can be a rotational pendulum-spring model. Other suitable models 152 can similarly be used. In some implementations, data obtained from the displacement sensors 140 can be input into the model(s) 152 to model the movement of the first portion (e.g., cab portion 204) relative to the second portion (e.g., chassis portion 202). In some implementations, data obtained from the displacement sensors 140, an IMU and/or wheel odometry sensor(s) can be input into the model(s) 152 to model the movement of the first portion (e.g., cab) relative to the second portion (e.g., chassis) as well as the orientation and/or position of the vehicle 10 within the surrounding environment.

In some implementations, the pose can be used to determine the motion plan for the vehicle 10. For example, the pose can describe how the vehicle 10 is oriented with respect to the surrounding environment, such as whether the vehicle 10 is pitching, rolling, or yawing, and a vehicle computing system 102 and/or a motion planning system 105 can use the pose to determine how to maneuver the vehicle 10 through the surrounding environment.

In some implementations, a computing system, such as a computing system 102 and/or one or more computing devices 111/130, can further cause the vehicle 10 to initiate travel in accordance with at least a portion of the motion plan. For example, the computing system 102 and/or a vehicle controller 106 can control a throttle system, brake system, steering system, and/or another vehicle system to cause the vehicle 10 to travel within the surrounding environment according to the motion plan.

Referring now to FIG. 8, an example method (800) to compensate for displacement between portions of a vehicle is depicted. Although FIG. 8 depicts steps performed in a particular order for purposes of illustration and discussion, the methods of the present disclosure are not limited to the particularly illustrated order or arrangement. The various steps of method (800) can be omitted, rearranged, combined, and/or adapted in various ways without deviating from the scope of the present disclosure. The method (800) can be implemented by a computing system, such as a computing system 102 comprising one or more computing devices 111/130. The computing devices can include, for example, one or more processors and one or more tangible, non-transitory computer-readable memory.

At (802), the method (800) can include obtaining data indicative of a displacement of a first portion of a vehicle, such as an autonomous vehicle, relative to a second portion of the vehicle. For example, in some implementations, the first portion can be a cab portion 204 and the second portion can be a chassis portion 202 of a vehicle 200. The vehicle can define a pitch axis and a roll axis perpendicular to one another. The first portion can be configured to move relative to the second portion, such as, for example, about the pitch axis and/or the roll axis.

In some implementations, the data indicative of a displacement can be obtained from one or more displacement sensors. For example, one or more displacement sensors 140 can be positioned to measure a displacement between the two portions. In some implementations, the one or more displacement sensors 140 can be associated with the pitch axis and/or the roll axis. In some implementations, the one or more displacement sensors 140 can be linear encoders, lasers, GPS antennas, or other linear displacement sensors.

At (804), the method (800) can include determining an orientation of the first portion about the pitch axis or the roll axis relative to the second portion based at least in part on the data indicative of the displacement. For example, in some implementations, the orientation of the first portion can be determined based on measurements from a displacement sensor 140 associated with the pitch axis and/or the roll axis.

For example, in some implementations, a displacement sensor 140A and/or displacement sensor 140B can be associated with a roll axis or pitch axis, respectively. In some implementations, the displacement sensors 140A/B can be configured to measure a displacement in a vertical direction perpendicular to the pitch and roll axes. The displacement can be, for example, along the vertical direction, or a vertical component of a displacement at an angle. In some implementations, the displacement sensors 140 A/B can be configured to measure a displacement along the plane defined by the pitch and roll axes. In some implementations, the orientation of the first portion relative to the second portion can be determined based at least in part on measurements from the displacement sensors 140A/B.

In some implementations, a first displacement sensor 140C and a second displacement sensor 140D can be both be configured to obtain measurements of a displacement of the first portion relative to the second portion. In some implementations, measurements from both the first displacement sensor 140C and the second displacement sensor 140D can be compared, and the orientation of the first portion relative to the second portion can be determined based at least in part on the comparison of the measurements. For example, the comparison can indicate that the first portion is pitching and/or rolling relative to the second portion.

At (806), the method (800) can include determining a pose of the vehicle. For example, in some implementations, a state estimator 150, such as a state estimator 150 comprising a Kalman filter, can be used to determine a pose of a vehicle 10. In some implementations, the pose can describe one or more of a roll, a pitch, or a yaw of the vehicle 10, or a position of the vehicle 10 in a surrounding environment of the vehicle 10.

For example, in some implementations, data indicative of a displacement obtained from one or more displacement sensors 140 can be provided to the state estimator 150, which can determine an orientation of the first portion relative to the second portion. Further, in some implementations, data from one or more sensors 101, such as data from one or more IMU's, wheel odometry sensors, LIDAR sensors, RADAR sensors, cameras, or other sensors, can also be provided to the state estimator to determine the pose.

In some implementations, the orientation of the first portion relative to the second portion and/or the pose of the vehicle 10 can be determined by one or more models 152. For example, in some implementations, the state estimator 150 can include one or more models 152 configured to model the movement of the first portion relative to the second portion and/or the pose of the vehicle 10 in the surrounding environment.

At (808), the method (800) can include determining a motion plan for the vehicle based at least in part on the pose. For example, in some implementations, a motion planning system 105 of a vehicle computing system 102 can be configured to use the pose to determine a motion plan for the vehicle 10. The motion plan can include, for example, a trajectory for the vehicle 10 to travel through the surrounding environment.

At (810), the method (800) can include causing the vehicle to initiate travel in accordance with at least a portion of the motion plan. For example, a vehicle controller 106 and/or vehicle controls 107 can send various control signals to a brake system, a throttle system, a steering system, or other vehicle system in order to cause the vehicle 10 to travel in accordance with at least a portion of the motion plan. In this way, the vehicle can be caused to initiate travel in accordance with the motion plan.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A system for compensating for displacement between portions of an autonomous vehicle, the autonomous vehicle defining a pitch axis and a roll axis, the pitch axis perpendicular to the roll axis, the system comprising:
a computing system comprising:
one or more processors; and
one or more tangible, non-transitory, computer readable media that collectively store instructions that when executed by the one or more processors cause the computing system to perform operations, the operations comprising:
obtaining data indicative of a displacement of a first portion of the autonomous vehicle relative to a second portion of the autonomous vehicle; and
determining an orientation of the first portion relative to the second portion about at least one of the pitch axis or the roll axis based at least in part on the data indicative of the displacement.

2. The system of claim 1, wherein the operations further comprise:
determining a pose of the autonomous vehicle based at least in part on the orientation of the first portion relative to the second portion.

3. The system of claim 2, wherein the operations further comprise:
generating a motion plan for the autonomous vehicle based at least in part on the pose of the autonomous vehicle; and
causing the autonomous vehicle to initiate travel in accordance with at least a portion of the motion plan.

4. The system of claim 2, wherein the pose comprises at least one of a roll, a pitch, or a yaw of the autonomous vehicle, or a position of the autonomous vehicle in a surrounding environment of the autonomous vehicle.

5. The system of claim 2, wherein the pose is determined via a state estimator comprising a Kalman filter.

6. The system of claim 5, wherein the Kalman filter comprises a model of the autonomous vehicle;
wherein the model comprises a model of the first portion moving about the pitch axis or the roll axis relative to the second portion.

7. The system of claim 1, further comprising:
one or more displacement sensors configured to obtain measurements of the displacement of the first portion of the autonomous vehicle relative to the second portion of the autonomous vehicle;
wherein the data indicative of the displacement is obtained from the one or more displacement sensors.

8. The system of claim 7, wherein at least one of the one or more displacement sensors comprises a linear encoder or a GPS antenna.

9. The system of claim 7, wherein the autonomous vehicle further defines a vertical direction perpendicular to the pitch axis and the roll axis;
wherein the one or more displacement sensors comprises a first displacement sensor associated with the roll axis;
wherein the first displacement sensor is configured to measure a displacement along the vertical direction; and
wherein determining an orientation of the first portion relative to the second portion about at least one of the pitch axis or the roll axis based at least in part on the data indicative of the displacement comprises determining an orientation of the first portion relative to the second portion about the roll axis based at least in part on data obtained from the first displacement sensor.

10. The system of claim 7, wherein the autonomous vehicle further defines a vertical direction perpendicular to the pitch axis and the roll axis;
wherein the one or more displacement sensors comprises a first displacement sensor associated with the pitch axis;
wherein the first displacement sensor is configured to measure a displacement along the vertical direction; and
wherein determining an orientation of the first portion relative to the second portion about at least one of the pitch axis or the roll axis based at least in part on the data indicative of the displacement comprises determining an orientation of the first portion relative to the second portion about the pitch axis based at least in part on data obtained from the first displacement sensor.

11. The system of claim 7, wherein the one or more displacement sensors comprises a first displacement sensor and a second displacement sensor; and
wherein determining an orientation of the first portion relative to the second portion about at least one of the pitch axis or the roll axis based at least in part on the data indicative of the displacement comprises comparing a first displacement measurement from the first displacement sensor to a second displacement measurement from the second displacement sensor.

12. The system of claim 1, wherein the first portion comprises a cab; wherein the second portion comprises a chassis; and wherein the cab is mounted atop the chassis.

13. A method for compensating for displacement between portions of an autonomous vehicle, the autonomous vehicle defining a pitch axis and a roll axis, the pitch axis perpendicular to the roll axis, the method comprising:
obtaining, by a computing system comprising one or more computing devices, data indicative of a displacement of a first portion of the autonomous vehicle relative to a second portion of the autonomous vehicle from one or more displacement sensors; and
determining, by the computing system, an orientation of the first portion relative to the second portion about the pitch axis or the roll axis based at least in part on the data indicative of the displacement.

14. The method of claim 13, further comprising:
determining, by the computing system, a pose of the autonomous vehicle based at least in part on the orientation of the first portion relative to the second portion;
generating, by the computing system, a motion plan for the autonomous vehicle based at least in part on the pose of the autonomous vehicle; and
causing, by the computing system, the autonomous vehicle to initiate travel in accordance with at least a portion of the motion plan.

15. The method of claim 14, wherein determining the pose comprises modeling, via a model of a state estimator, the first portion moving about at least one of the pitch axis or the roll axis relative to the second portion.

16. The method of claim 13, wherein the one or more displacement sensors comprises at least one linear encoder.

17. The method of claim 13, wherein the autonomous vehicle further defines a vertical direction perpendicular to the pitch axis and the roll axis;
wherein the one or more displacement sensors comprise one or more displacement sensors associated with the pitch axis or the roll axis; and
wherein the one or more displacement sensors are configured to measure a displacement along the vertical direction.

18. The method of claim 13, wherein the one or more displacement sensors comprises a first displacement sensor and a second displacement sensor; and
wherein determining, by the computing system, the orientation of the first portion relative to the second portion about the pitch axis or the roll axis based at least in part on the data indicative of the displacement comprises comparing data indicative of a first displacement measurement from the first displacement sensor to data indicative of a second displacement measurement from the second displacement sensor.

19. A vehicle, the vehicle defining a pitch axis, a roll axis, and a vertical direction, the pitch axis perpendicular to the roll axis, the vertical direction perpendicular to the pitch axis and the roll axis, the vehicle comprising:
a chassis;
a cab mounted atop the chassis along the vertical direction;
a first displacement sensor associated with at least the pitch axis, the first displacement sensor configured to obtain measurements of a displacement of the cab relative to the chassis in the vertical direction;
a second displacement sensor associated with at least the roll axis, the second displacement sensor configured to obtain measurements of a displacement of the cab relative to the chassis in the vertical direction; and
a computing system, comprising:
one or more processors; and
one or more tangible, non-transitory, computer readable media that collectively store instructions that when executed by the one or more processors cause the computing system to perform operations, the operations comprising:
obtaining data indicative of a displacement of the cab relative to the chassis from the first displacement sensor or the second displacement sensor; and
determining an orientation of the cab relative to the chassis about at least one of the pitch axis or the roll axis based at least in part on the data indicative of the displacement.

20. The vehicle of claim 19, wherein determining an orientation of the cab relative to the chassis about at least one of the pitch axis or the roll axis based at least in part on the data indicative of the displacement comprises comparing a first displacement measurement from the first displacement sensor to a second displacement measurement from the second displacement sensor.
